(19) United States
(12) Patent Application Publication
(10) Pub. No.: US 2016/0069382 A1
(43) Pub. Date: Mar. 10, 2016

(54) NODULAR IRON CAST CRANKSHAFT WITH FORGED STEEL CORE INSERT

(71) Applicant: Ford Global Technologies, LLC, Dearborn, MI (US)

(72) Inventors: Jeffrey Eliot Chottiner, Farmington Hills, MI (US); Rick L. Williams, Canton, MI (US)

(21) Appl. No.: 14/477,313

(22) Filed: Sep. 4, 2014

(51) Int. Cl. F16C 3/08; B23P 13/00; F16F 15/28; B32B 15/01

(52) U.S. Cl. CPC F16C 3/08; B32B 15/011; B23P 13/00; F16F 15/283

(57) ABSTRACT

A crankshaft for an internal combustion engine having a core formed from a first material and an outer layer formed from a second material, the second material being different from the first material, is disclosed. Both the first and second materials are preferably though not absolutely metals. The crankshaft core is preferably formed from forged steel, such as C1117 AISI or similar steel. The layer formed over the crankshaft core is preferably iron, such as nodular iron. The crankshaft core is preferably formed having an orienting keystone lock at each end. The iron layer formed over the crankshaft core may be of a variety of irons, though nodular iron is preferred. The disclosed crankshaft thus provides an alternative to the traditional forged steel crankshaft by utilizing a low cost, forged steel core and cast a nodular iron outer layer that includes the counterweights, cheeks, post, flange and journals.

### TECHNICAL FIELD

The disclosed inventive concept relates generally to crankshafts for internal combustion engines. More particularly, the disclosed inventive concept relates to a crankshaft having a low cost forged steel core for strength and a nodular iron outer layer formed around the forged steel core. The outer cast layer includes the counterweights, cheeks, post, flange and journals. Thus formed, the diameters of the journals can be reduced to reduce mechanical friction without reducing durability of the crankshaft.

### BACKGROUND OF THE INVENTION

A critical component of the internal combustion engine is the crankshaft. Certain improvements have been made to the crankshaft since the earliest days of engine manufacturing.

However, further advancements are needed. One of the greatest challenges confronting engineers is that of crankshaft friction. As is known, the crankshaft rotates against main bearing journals formed as part of the engine block. These bearing surfaces, while lubricated, create efficiency-compromising friction. Additional efficiency-compromising friction is created between the connecting rods and the connecting rod journals formed on the crankshaft.

In an effort to decrease the friction created upon rotation of the crankshaft, lubricants having decreased viscosity have been developed. While contributing to the reduction in rotational friction of the crankshaft, other opportunities for reducing friction yet exist.

One concept being advanced to decrease the amount of main and rod bearing mechanical friction produced by the crankshaft is to reduce the sizes of the crankshaft journals, thus reducing overall surface area and consequentially reducing friction. However, this concept, when introduced into practice, is challenged by known crankshaft manufacturing techniques.

According to known production techniques, the typical crankshaft is either of a forged steel design or is cast nodular iron depending on the engine load characteristics. As a general matter, crankshafts formed by forging are stronger than those formed by casting.

In the forging process, a hot steel billet (typically composed of SAE 1045 or a similar steel) is processed by way of a series of forging dies whereby the billet shape is changed slightly with each forging stage. According to known techniques, the resulting blanks then undergo an extensive machining process. During the machining process, it may be that the sizes of the crankshaft journals could be reduced, since the forged steel crankshaft is very dense and thus durable. However, the cost of producing a forged crankshaft, regardless of the diameters of the journals, is relatively high due to both material and machining costs. So while the forged crankshaft is a better candidate for journals of a reduced size, this approach is cost-prohibitive.

Conversely, the production of cast nodular iron crankshafts is lower in cost because the initial casting can be made relatively close to the desired final shape and size. The casting process allows for the production even of crankshafts having complex shapes with minimal post-production machining. Only the machining of the bearing surfaces and the finishing of the drive ends needs to be undertaken.

However, while lower in cost to produce due to less required machining, the reduction in journal sizes drastically reduces the durability characteristics of a typical cast nodular iron crankshaft. The nodular iron crankshaft becomes weaker in bending and demonstrates lowered torsional and fatigue strength.

The typical approach of improving these crankshaft design characteristics is to change the material from a cast nodular iron to a forged steel option but, as discussed above, the forged steel crankshaft adds considerable manufacturing costs when compared to the cast nodular iron design.

In summary, finding an economical crankshaft design solution that reduces main and rod bearing friction while meeting all the crankshaft durability requirements is a problem that remained unsolved until the present invention.

### SUMMARY OF THE INVENTION

The disclosed inventive concept overcomes the problems associated with known approaches to producing crankshafts for internal combustion engines. The disclosed inventive concept provides a finished and durable crankshaft having a low cost forged steel core with a nodular iron outer layer formed over the core. Particularly, the cast nodular iron crankshaft having a forged steel core of the disclosed inventive concept offers a lower cost manufacturing solution while improving the overall durability characteristics when compared to a conventional cast iron crankshaft.

The crankshaft for an internal combustion engine of the disclosed inventive concept includes a crankshaft core formed from a first material and a layer formed over the crankshaft core that is formed from a second material that is different from the first material. Both the first and second materials are preferably though not absolutely metals. The crankshaft core is preferably formed from forged steel, such as C1117 AISI or similar steel. The layer formed over the crankshaft core is preferably iron, such as nodular iron. The crankshaft core is preferably formed having an orienting keystone lock at each end.

While carbon is typically the primary alloying element found in all carbon steels, other elements, such as copper, nickel, chromium, aluminum and molybdenum are also present, though in lesser quantities. By having more manganese than other steels, C1117 AISI provides superior hardenability. However, while C1117 AISI is a known preferred steel because of its hardenability, other steels that demonstrate superior hardenability may be suitable as well.

The iron layer formed over the crankshaft core may be of a variety of irons, though nodular iron is preferred. “Nodular iron” (also known as “ductile iron” and “spheroidal graphite iron”) refers to iron that is strengthened through the inclusion of graphite in nodular form as opposed to in the form of individual flakes as is the case in gray iron. In addition, nodular iron typically contains cerium or magnesium. Other additives may be included. This novel combination gives nodular iron a high degree of impact and fatigue resistance compared with gray iron. Thus nodular iron is ideally suited as the outer layer in the cast nodular iron crankshaft of the disclosed inventive concept.

The disclosed inventive concept provides an alternative to the traditional higher manufacturing cost of a forged steel crankshaft by utilizing a low cost, forged steel core and cast a nodular iron outer layer that includes the counterweights, cheeks, post, flange and journals. Due to the casting tolerances versus the forging tolerances the counterweights on this design could be as-cast, thus rendering machining unnecessary and further reducing manufacturing cost. This lower cost design would allow the journal sizes to be reduced (thus improving bearing friction) while enhancing the bending, torsional and fatigue characteristics require to meet the crankshaft durability requirements.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a perspective view of a forged steel core insert of a nodular iron cast crankshaft according to the disclosed inventive concept;

FIG. 2 is the sectional side view of a nodular iron cast crankshaft having the forged steel core insert of FIG. 1; and

FIG. 3 is a perspective view of the cast nodular iron crankshaft of FIG. 2 illustrating the forged steel core in broken lines.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

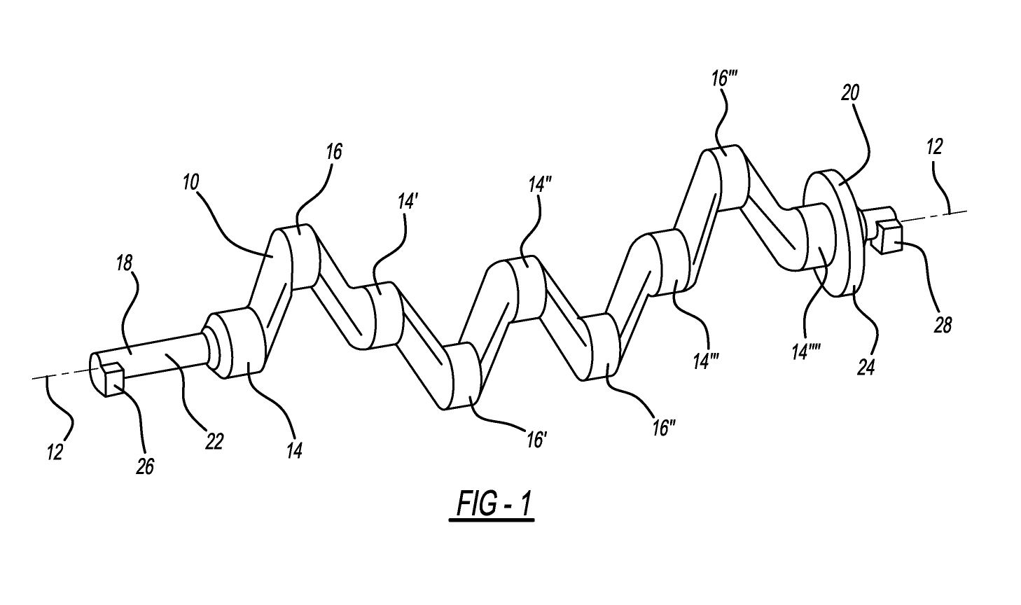

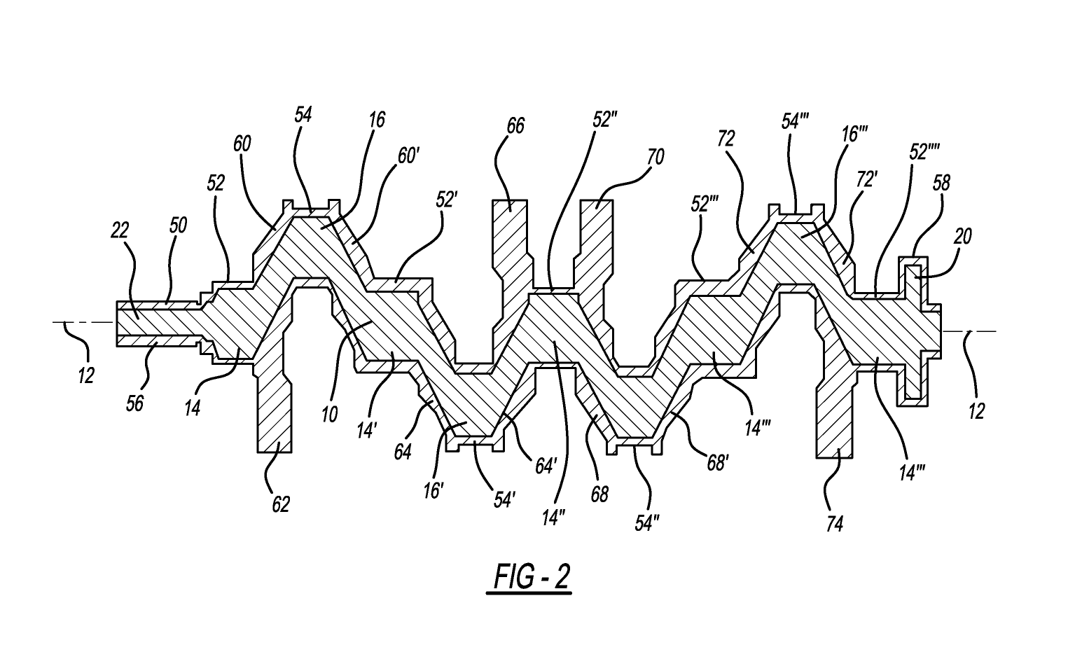

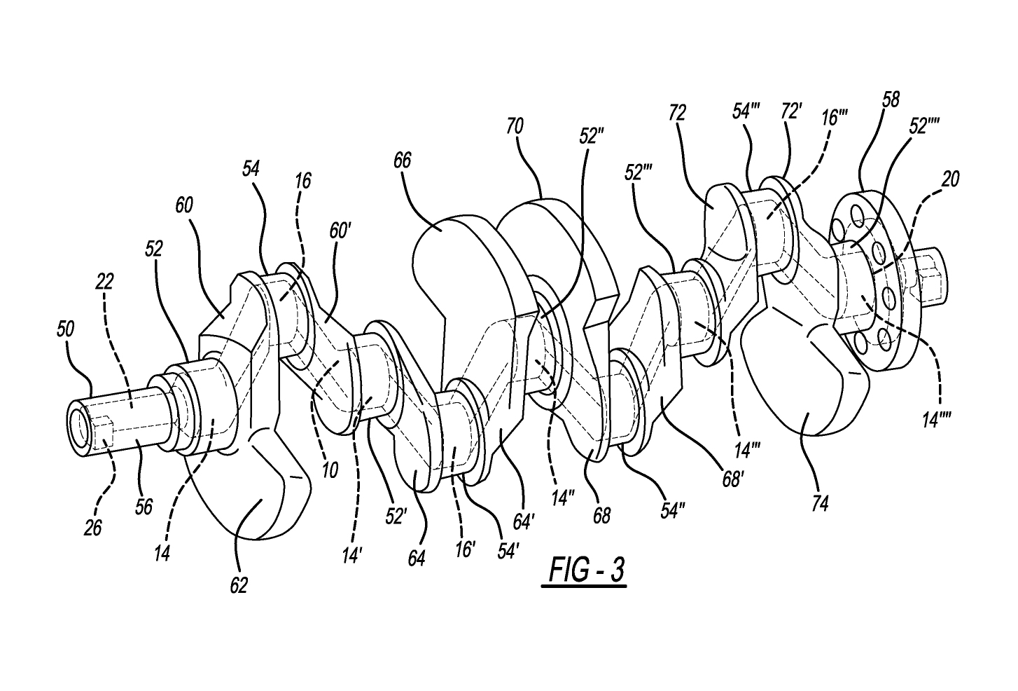

Referring to FIG. 1, a perspective view of a forged steel crankshaft core for use in the nodular iron cast crankshaft for an internal combustion engine according to the disclosed inventive concept is illustrated. FIGS. 2 and 3 are views of the nodular iron cast crankshaft having a forged steel core insert in which the insert is shown. It is to be understood that the overall configuration of the illustrated nodular iron cast crankshaft having a forged steel core insert is set forth in FIGS. 1, 2 and 3 for suggestive purposes only as the overall configuration may be altered from that illustrated.

Referring to FIG. 1, a forged steel core insert 10 has a rotational axis 12. The forged steel crankshaft core may be formed from any one of several forged steels, such as but not limited to C1117 AISI. The forged steel core insert 10 includes main journal areas 14, 14′, 14″, 14′″ and 14″″. The forged steel core insert 10 further includes rod journal areas 16, 16′, 16″ and 16′″ that are formed between the main journal areas 14, 14′, 14″, 14′″ and 14″″.

The forged steel core insert 10 includes a first end 18 and a second end 20. Extending from one end, in this case the first end 18, is a shaft area 22. Extending from the other end of the forged steel core insert 10, in this case the second end 20, is a flywheel flange area 24. Integrally formed with the shaft area 22 of the first end 18 is a first keystone lock 26 for forged steel core orientation. Integrally formed with the flywheel flange area 24 of the second end 20 is a second keystone lock 28 also for forged steel core orientation.

FIGS. 2 and 3 illustrate the nodular iron cast crankshaft of the disclosed concept having the forged steel crankshaft core according to the disclosed inventive concept. More particularly, and referring to both FIGS. 2 and 3, an iron cast crankshaft 50 having the forged steel core insert 10 is illustrated. Preferably, but not absolutely, the iron is nodular iron.

Rotation of the nodular iron cast crankshaft 50 about the rotational axis 12 is made possible by the provision of main journals 52, 52′, 52″, 52′″ and 52″″ respectively formed on the main journal areas 14, 14′, 14″, 14′″ and 14″″. The main journals 52, 52′, 52″, 52′″ and 52″″ are integrally formed as part of the nodular iron cast crankshaft 50 and are restrained within the engine block (not shown) by crankshaft bearings (not shown).

Rod journals 54, 54′ 54″ and 54′″ are formed on the rod journal areas 16, 16′, 16″ and 16″. The engine connecting rods (not shown) are attached as is known in the art to the rod journals 54, 54′ 54″ and 54′″ by rod bearings. The rod journals 54, 54′ 54″ and 54″″ are integrally formed on the nodular iron cast crankshaft 50, again as is known in the art.

Formed over the shaft area 22 is a shaft 56. The shaft 56 serves as a mount for any number of engine components, such as a damper, a fan belt pulley and a drive mechanism for a camshaft. None of these components is shown but these components and their methods of attachment are known to those skilled in the art.

Formed over the flywheel flange 24 area is a flywheel flange 58 to which a flywheel (not shown) is attached. The flywheel, which assists in reducing torsional fluctuations in the nodular iron cast crankshaft 50, is in operative engagement with the drive shaft or transaxle of the vehicle.

To each side of the rod journal 54 is provided a spaced apart pair of crank webs 60 and 60′. Extending from the crank web 60 is a counterweight 62.

To each side of the rod journal 54′ is provided a spaced apart pair of crank webs 64 and 64′. Extending from the crank web 60 is a counterweight 66.

To each side of the rod journal 54″ is provided a spaced apart pair of crank webs 68 and 68′. Extending from the crank web 68 is a counterweight 70.

To each side of the rod journal 54″″ is provided a spaced apart pair of crank webs 72 and 72′. Extending from the crank web 72′ is a counterweight 74.

The crankshaft of the disclosed inventive concept is produced according to the following general steps. First, a two-piece, split mold having a crankshaft-shaped cavity is formed in a known manner. Second, a crankshaft core is formed by forging a blank of steel material to a desired shape. Third, the forged steel crankshaft core is placed substantially within the cavity of the two-piece, split mold. Fourth, the two-piece, split mold is closed. Fifth, molten nodular iron is introduced into the cavity to form a crankshaft. Sixth, the mold is opened and the semi-finished crankshaft is removed from the mold. Seventh, the semi-finished crankshaft is finished by selective machining.

The disclosed inventive concept provides a method of forming a crankshaft having a highly durable forged steel core insert with nodular iron cast around the core. According to this arrangement, the benefits of strength (provided by the forged steel core insert) with relatively minimal and easy machining (provided by the outer iron casting) are achieved at a relatively low cost. Thus the disclosed inventive concept overcomes the problems associated with known crankshafts in practical and cost-effective manner.

One skilled in the art will readily recognize from such discussion, and from the accompanying drawings and claims that various changes, modifications and variations can be made therein without departing from the true spirit and fair scope of the invention as defined by the following claims.

What is claimed is:

1. A crankshaft for an internal combustion engine comprising:
a forged crankshaft core made of steel; and
an iron layer formed over said core by casting, said cast iron layer including at least one counterweight, at least one pair of cheeks, a post, a flange and journals.

2. The crankshaft for an internal combustion engine of claim 1 wherein said forged steel is substantially similar to C1117 AISI steel.

3. The crankshaft for an internal combustion engine of claim 1 wherein said forged steel is C1117 AISI steel.

4. The crankshaft for an internal combustion engine of claim 1 wherein said cast iron layer is formed from nodular iron.

5. The crankshaft for an internal combustion engine of claim 1 wherein said core has a first end and a second end and wherein an orienting keystone lock is formed on each of said ends.

6. A crankshaft for an internal combustion engine comprising:
a crankshaft core formed from a first material; and
a layer formed over said crankshaft core, said layer being formed from a second material, said first and second materials being different.

7. The crankshaft for an internal combustion engine of claim 6 wherein said layer is machined whereby at least one bearing surface is formed thereon.

8. The crankshaft for an internal combustion engine of claim 6 wherein said first material is a metal.

9. The crankshaft for an internal combustion engine of claim 8 wherein said metal is steel.

10. The crankshaft for an internal combustion engine of claim 9 wherein said steel is forged steel.

11. The crankshaft for an internal combustion engine of claim 10 wherein said forged steel is substantially similar to C1117 AISI steel.

12. The crankshaft for an internal combustion engine of claim 6 wherein said forged steel is C1117 AISI steel.

13. The crankshaft for an internal combustion engine of claim 6 wherein said second material is a metal.

14. The crankshaft for an internal combustion engine of claim 13 wherein said metal is cast iron.

15. The crankshaft for an internal combustion engine of claim 14 wherein said cast iron is nodular iron.

16. The crankshaft for an internal combustion engine of claim 6 wherein said core has a first end and a second end and wherein an orienting keystone lock is formed on each of said ends.

17. A method for making a crankshaft for an internal combustion engine comprising the steps of:
forming a mold having a cavity;
forming a crankshaft core by forging a blank of steel material to a desired shape;
placing said crankshaft core substantially within said cavity;
introducing molten iron into said cavity to form a crankshaft;
removing said crankshaft from said mold; and
selectively machining said crankshaft.

18. The method for making a crankshaft of claim 17 wherein said steel is C1117 AISI steel.

19. The method for making a crankshaft of claim 17 wherein said iron is nodular iron.

20. The method for making a crankshaft of claim 17 including the steps of forming a first end and a second end on said crankshaft core and forming an orienting keystone lock on each of said ends.
